(19) United States
(12) Patent Application Publication
(10) Pub. No.: US 2017/0132670 A1
(43) Pub. Date: May 11, 2017

(54) USER KEY IDENTIFICATION SYSTEM, APPARATUS UTILIZED THEREFOR, AND METHOD FOR OPERATING SAME

(71) Applicant: SK PLANET CO., LTD., Seongnam-si, Gyeonggi-do (KR)

(72) Inventor: Min Ho HAN, Seoul (KR)

(73) Assignee: SK Planet Co., Ltd.

(21) Appl. No.: 15/321,953

(22) PCT Filed: Dec. 11, 2015
(86) PCT No.: PCT/KR2015/013578

§ 371 Date: Dec. 23, 2016

(30) Foreign Application Priority Data
Jan. 2, 2015 (KR) 10-2015-0000250

(51) Int. Cl. G06Q 30/02; G06F 17/18; H04L 29/08; G06F 17/30

(52) U.S. Cl. CPC G06Q 30/0277; G06F 17/30867; G06F 17/18; H04L 67/18

(57) ABSTRACT

Disclosed herein are a user key identification system, an apparatus applied thereto and an operation method of the apparatus for identifying different user keys assigned to the same terminal and managing the same with one user key in an environment where multiple different user keys are assigned to one terminal.

### TECHNICAL FIELD

The present disclosure relates to a technology for identifying different user keys assigned to the same terminal and further managing different user keys assigned to the same terminal with one user key in an environment where different user keys are assigned to the same terminal.

### BACKGROUND ART

It is a recent trend to provide targeted (personalized) advertisement services to terminal users. In providing a personalized advertisement service to a user, a technology for identifying an individual user is important.

Generally, in order to identify an individual user of a terminal in an advertisement platform for providing an advertisement service, a terminal is identified based on a user key that can be verified from information generated by a drive unit (e.g., SDK) which is installed in the terminal to request and receive an advertisement. Of course, the user key is issued (assigned) uniquely to the drive unit (e.g., SDK) of the terminal by the advertisement platform.

An application drive unit (hereinafter, an App SDK) for requesting and receiving an advertisement based on an application (App) and a web drive unit (hereinafter, a Web SDK) for requesting and receiving an advertisement based on a Web may be installed in the terminal. In this case, a user key will be assigned to each of the application SDK and the Web SDK.

The reason for allocating user keys to the application SDK and the Web SDK respectively is that the App SDK cannot access the cookie in which a user key assigned to the Web SDK (hereinafter, Web user key) is stored, and the Web SDK cannot access the SD card of the terminal, in which a user key assigned to the App SDK (hereinafter, App user key) is stored.

When multiple different user keys (an App user key, a Web user key) are allocated to one terminal as described above, the advertisement platform verifies the different user keys, namely, the App user key and the Web user key from the separate information generated by each of App SDK and Web SDK of the same terminal, and accordingly cannot recognize that the information items are from the same individual user of the same terminal.

If multiple different user keys (an App user key and a Web user key) are assigned to one terminal, but the advertisement platform cannot recognize that information generated from each of the App SDK and Web SDK of the same terminal indicates the same individual user, as discussed above, the accuracy of identifying the individual user will be lowered and performance of the personalized advertisement service will be degraded.

In view of the above, the present disclosure provides a method of identifying different user keys assigned to the same terminal and managing the different user keys with one user key in an environment where multiple different user keys are assigned to one terminal.

### DISCLOSURE

### Technical Problem

It is an object of the present disclosure to provide a user key identification system, an apparatus applied thereto and an operation method of the apparatus for identifying different user keys assigned to the same terminal and managing the same with one user key in an environment where multiple different user keys are assigned to one terminal.

### Technical Solution

In accordance with an aspect of the present disclosure, a user key identification apparatus includes a collector for collecting specific information including user keys and location information from each terminal, a verification unit for verifying user keys of location information belonging to a specific location area in each time zone based on a result of collection of the specific information, a first filtering unit for filtering a pair of user keys having a probability of belonging to the specific location area in the same time zone among the user keys verified by the verification unit, the probability being greater than or equal to a first predetermined reference value, and a key identification unit for identifying different user keys included in a specific user key pair among user key pairs filtered by the first filtering unit as user keys assigned to the same specific terminal.

Specifically, the user key identification apparatus may further include a second filtering unit for filtering a user key pair having a probability of belonging to the specific location area on the same date greater than or equal to a second predetermined reference value among the user key pairs filtered by the first filtering unit as the specific user key pair on the basis of an analysis result obtained by analyzing the result of collection by date.

Specifically, the specific information may be advertisement request information generated by at least one of an application drive unit for requesting and receiving an application-based advertisement in the terminal and a Web drive unit for requesting and receiving a web-based advertisement in the terminal, using a pre-assigned user key.

Specifically, the different user keys included in the specific user key pair may be assigned differently to the App drive unit and the Web drive unit installed in the specific terminal, respectively.

Specifically, the first filtering unit may be configured to check the number of time zones of a first user key belonging to the specific location area within a predefined time range among the user keys verified by the verification unit, check the number of time zones of a second user key belonging to the specific location area same as the time zones of the first user key within the time range among the user keys verified by the verification unit, calculate a probability of belonging to the specific location area in the same time zones based on the number of the time zones of the first user key and the number of the same time zones of the second user key, and filter, when the calculated probability is greater than or equal to the first reference value, the first user key and the second user key as a user key pair.

Specifically, the first user key may be a user key sequentially selected from among the user keys verified by the verification unit according to the number of times of collection of related specific information within the time range, wherein the second user key may be each of remaining user keys except for the first user key among the user keys verified by the verification unit.

Specifically, the second filtering unit may be configured to check, for each of the user key pairs filtered by the first filtering unit, the number of time zones of a first user key belonging to the specific location area within a previous date immediately preceding a current date, and the number of time zones of the current date of a second user key belonging to the specific location area the same as the time zones of the first user key, calculate, for each of the user key pairs filtered by the first filtering unit, a probability that the first user key and the second user key belong to the specific location area on the same date, based on the number of the time zones of the first user key on the previous date and the number of the same time zones of the second user key on the current date, and filter a user key pair having the calculated probability greater than or equal to the second reference value among the user key pairs filtered by the first filtering unit as a specific user key pair.

Specifically, the different user keys included in the specific user key pair may include a first user key assigned to one of the application drive unit and the Web drive unit installed in the specific terminal, and a second user key assigned to the other one of the application drive unit and the Web drive unit, and the user key identification apparatus may further include a key control unit for sending the first user key upon receiving the advertisement request information generated using the second user key from any one of the application drive unit and the Web drive unit such that both the application drive unit and the Web drive unit installed in the specific terminal use the first user key.

In accordance with another aspect of the present disclosure, a method of operating a user key identification apparatus includes performing a collecting step of collecting specific information including user keys and location information from each terminal, performing a verifying step of verifying user keys of location information belonging to a specific location area in each time zone based on a result of collection of the specific information, performing a first filtering step of filtering a pair of user keys having a probability of belonging to the specific location area in the same time zone among the user keys verified by the verification unit, the probability being greater than or equal to a first predetermined reference value, and performing a key identifying step of identifying different user keys included in a specific user key pair among the user key pairs filtered in the first filtering step as user keys assigned to the same specific terminal.

Specifically, the method may further include performing a second filtering step of filtering a user key pair having a probability of belonging to the specific location area greater than or equal to a second predetermined reference value among the user key pairs filtered by the first filtering unit on the basis of an analysis result obtained by analyzing the result of collection by date, as the specific user key pair.

Specifically, the specific information may be advertisement request information generated by at least one of an application drive unit for requesting and receiving an application-based advertisement in the terminal and a Web drive unit for requesting and receiving a web-based advertisement in the terminal, using a pre-assigned user key.

Specifically, the different user keys included in the specific user key pair may be assigned differently to the application drive unit and the Web drive unit installed in the specific terminal, respectively.

Specifically, the first filtering step may include checking the number of time zones of a first user key belonging to the specific location area within a predefined time range among the user keys verified in the verifying step, checking the number of time zones of a second user key belonging to the specific location area same as the time zones of the first user key within the time range among the user keys verified in the verifying step, calculating a probability of belonging to the specific location area in the same time zones based on the number of the time zones of the first user key and the number of the same time zones of the second user key, and filtering, when the calculated probability is greater than or equal to the first reference value, the first user key and the second user key as a user key pair.

Specifically, the second filtering step may include checking the number of time zones of a first user key belonging to the specific location area within a previous date immediately preceding a current date for each of the user key pairs filtered in the first filtering step, and the number of time zones of the current date of a second user key belonging to the specific location area the same as the time zones of the first user key, calculating a probability that the first user key and the second user key in each of the user key pairs filtered in the first filtering step belong to the specific location area on the same date, based on the number of the time zones of the first user key on the previous date and the number of the same time zones of the second user key on the current date, and filtering a user key pair having the calculated probability greater than or equal to the second reference value among the user key pairs filtered in the first filtering step as a specific user key pair.

Specifically, the different user keys included in the specific user key pair may include a first user key assigned to one of the application drive unit and the Web drive unit installed in the specific terminal, and a second user key assigned to the other one of the application drive unit and the Web drive unit, and the method may further include sending the first user key upon receiving the advertisement request information generated using the second user key from any one of the application drive unit and the Web drive unit such that both the application drive unit and the Web drive unit installed in the specific terminal use the first user key.

In accordance with an aspect of the present disclosure, a user key identification system includes terminals for providing advertisement request information generated by at least one of an application drive unit and a Web drive unit, using a pre-assigned user key, and a user key identification apparatus for collecting the advertisement request information including user keys and location information from each of the terminal, verifying user keys of location information belonging to a specific location area in each time zone based on a result of collection of the advertisement request information, filtering a pair of user keys having a probability of belonging to the specific location area in the same time zone among the verified user keys, the probability being greater than or equal to a first predetermined reference value, and identifying different user keys included in a specific user key pair among the filtered user key pairs as user keys assigned to the same specific terminal.

### Advantageous Effects

According to a user key identification system, the user key identification apparatus, and a method of operating the user key identification apparatus of the present disclosure, different user keys assigned to the same terminal may be identified and managed with one user key in an environment where multiple different user keys are assigned to one terminal.

### DESCRIPTION OF DRAWINGS

FIG. 1 is an exemplary diagram illustrating a user key identification system according to an embodiment of the present disclosure.

FIG. 2 is an exemplary diagram illustrating a configuration of a user key identification apparatus according to an embodiment of the present disclosure.

FIG. 3 is a flowchart illustrating a method of operating a user key identification apparatus according to an embodiment of the present disclosure.

### BEST MODE

It is noted that the technical terms used herein are used only to describe specific embodiments and are not intended to limit the scope of the teachings disclosed herein. Also, the technical terms used herein should be interpreted in a sense that is generally understood by a person having ordinary skill in the art to which the presently disclosed technology belongs, unless the context clearly dictates otherwise and should not be construed in a broader sense or in an oversimplified sense. In addition, where technical terms used herein are inappropriate to exactly express the technical idea disclosed herein, they should be replaced with technical terms that allow the person in the art to properly understand. Also, the general terms used in the present disclosure should be interpreted in accordance with definitions in the dictionary and the predefined or prior context, and should not be construed as being excessively reduced in meaning.

As used herein, the singular form of “a,” “an,” and “the” include plural references unless the context clearly dictates otherwise. As used herein, the terms “consisting of,” “comprising,” etc., should not be construed as necessarily including all of the elements or steps listed thereafter, but some of the elements or steps may be omitted or additional elements or steps may further included.

Furthermore, the terms first, second and the like in the description and in the claims are used for distinguishing between similar elements and not necessarily for describing a sequential or chronological order. The terms are used only for distinguishing one component from another component. The terms so used are interchangeable under appropriate circumstances, e.g., a first component may be referred to as a second component and vice versa without departing from the scope of the present disclosure.

In the following detailed description, exemplary embodiments of the present disclosure will be described in detail with reference to the accompanying drawings. Throughout the drawings, like elements will be denoted by the same reference numerals and redundant descriptions will be omitted.

Detailed descriptions of well-known functions and structures incorporated herein will be omitted to avoid obscuring the gist of the technology disclosed herein. In addition, it is to be noted that the accompanying drawings are provided merely to facilitate understanding of the technical idea disclosed herein and that the scope of the technical idea is not limited thereby.

Hereinafter, an exemplary embodiment of the present disclosure will be described with reference to the accompanying drawings.

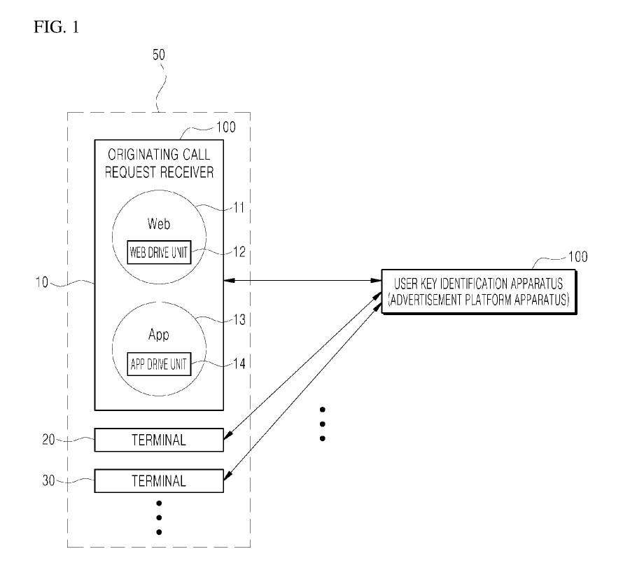

Initially, a user key identification system according to an embodiment of the present disclosure will be described with reference to FIG. 1.

As shown in FIG. 1, the user key identification system of the present disclosure includes a plurality of terminals 50 and a user key identification apparatus 100 for collecting specific information including a user key and location information from each of the terminals 50 and identifying different user keys assigned to the same terminal based on the specific information.

The terminals 50, which are capable of using at least one of an application-based advertisement service and a web-based advertisement service, may include, for example, a mobile phone terminal (e.g., a smart phone), and a notebook computer.

Among such terminals 50, a terminal 10 will be described.

At least one of an App drive unit 14 for requesting and receiving an advertisement based on an application 13 and a Web drive unit 12 for requesting and receiving an advertisement based on a Web 11 may be installed in the terminal 10. In this case, the App drive unit 14 may be an App SDK, and the Web drive unit 12 may be a Web SDK.

Hereinafter, for simplicity, it is assumed that both the App drive unit 14 and the Web drive unit 12 are installed in the terminal 10. Of course, a plurality of Apps 13 may be installed in the terminal 10. In this case, a plurality of App drive units 14 may be installed.

A user key will be issued (assigned) to each of the App drive unit 14 and the Web drive unit 12. The App drive unit 14 will store the assigned user key (hereinafter, a App user key) in the SD card (not shown) in the terminal 10, and the Web drive unit 12 will store the assigned user key (hereinafter, a Web user key) in a cookie.

Then, if necessary, the App drive unit 14 of the terminal 10 may generate advertisement request information using the App user key stored in the SD card (not shown), provide the advertisement request information to an advertisement platform (not shown) to request an advertisement, and display, on the terminal 10, the advertisement received in response to the request.

The advertisement request information generated by the App drive unit 14 includes an application user key assigned to the App drive unit 14, and also includes current location information on the assumption that the terminal 10 has agreed to collect location information

Meanwhile, if necessary, the Web drive unit 12 of the terminal 10 generates advertisement request information using the Web user key stored in the cookie, provides the advertisement request information to the advertisement platform (not shown) to request an advertisement, and displays, on the terminal 10, the advertisement received in response to the request.

The advertisement request information generated by the Web drive unit 12 includes a Web user key assigned to the Web drive unit 12, and also includes current location information on the assumption that the terminal 10 has agreed to collect the location information.

In the case where multiple different user keys, that is, the App user key and the Web user key, are assigned to one terminal (e.g., the terminal 10) as described above, the advertisement platform (not shown) verifies different user keys, i.e., the application user key and the Web user key, from the advertisement request information generated by each of the App drive unit and the Web drive unit of the same terminal, and thus cannot identify that the different user keys are from the individual user of the same terminal.

If multiple different user keys (an App user key and an Web user key) are assigned to one terminal, but the advertisement platform (not shown) cannot identify advertisement request information generated from each of the App SDK and Web SDK of the same terminal as information indicating the same individual user, as discussed above, the accuracy of identifying the individual user will be lowered and performance of the personalized advertisement service will be degraded.

In view of the above, the present disclosure provides a method of identifying different user keys assigned to the same terminal and managing the different user keys with one user key in an environment where multiple different user keys are assigned to one terminal.

To this end, the user key identification apparatus 100 of the present disclosure collects specific information including user keys and location information, that is, the above-described advertisement request information from each of the multiple terminals 50, and identifies different user keys assigned to the same terminal based on the result of collection.

More specifically, the user key identification apparatus 100 may collect advertisement request information including user keys and location information from each of the terminals 50, and verify user keys of location information belonging to a specific location area according to each time zone on the basis of the result of collection of the advertisement request information. Then, the user key identification apparatus 100 may filter a user key pair having a probability of belonging to the specific location area in the same time zone which is greater than or equal to a first predetermined reference value among the user keys identified. Then, the user key identification apparatus 100 may identify different user keys included in a specific user key pair among the filtered user key pairs as user keys assigned to the same terminal

The user key identification apparatus 100 may be an advertisement platform device included in an advertisement platform (not shown) to receive advertisement request information.

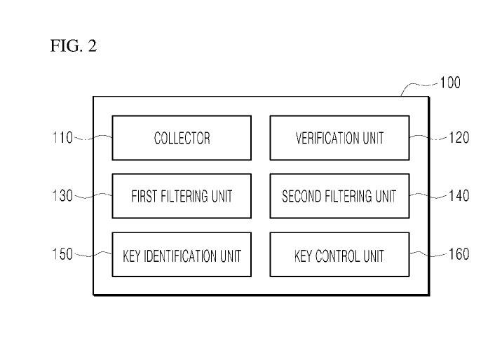

Hereinafter, the configuration of a user key identification apparatus according to an embodiment of the present disclosure will be described in more detail with reference to FIG. 2.

The user key identification apparatus 100 according to the present disclosure includes a collector 110 for collecting specific information including user keys and location information from each terminal, a verification unit 120 for verifying user keys of location information belonging to a specific location area in each time zone based on a result of collection of the specific information, a first filtering unit 130 for filtering a pair of user keys having a probability of belonging to the specific location area in the same time zone greater than or equal to a first predetermined reference value among the verified user keys and a key identification unit 150 for identifying different user keys included in a specific user key pair among the filtered user key pairs as user keys assigned to the same specific terminal.

The user key identification apparatus 100 according to the present disclosure may further include a second filtering unit 140.

The collector 110 collects specific information including user keys and location information from each terminal, for example, each of the terminals 50 shown in FIG. 1.

Here, the specific information may be advertisement request information which at least one of an App drive unit for requesting and receiving an app-based advertisement and a Web drive unit for requesting and receiving a web-based advertisement in a terminal generates using a user key pre-assigned thereto.

Hereinafter, description will be given focusing on the terminal 10 among the multiple terminals 50. The specific information collected from the terminal 10 is advertisement request information which at least one of the App drive unit 14 and the Web drive unit 12 in the terminal 10 generates using a user key pre-assigned thereto.

The advertisement request information generated by the App drive unit 14 of the terminal 10 includes a user key issued (assigned) to the App drive unit 14, i.e., an App user key, and also includes current location information on the assumption that the terminal 10 has agreed to collect the location information.

The advertisement request information generated by the Web drive unit 12 of the terminal 10 includes a user key issued (assigned) to the Web drive unit 12, i.e., a Web user key, and also includes current location information on the assumption that the terminal 10 has agreed to collect the location information.

Hereinafter, it is assumed that all the terminals 50 have agreed to collect location information.

The collection unit 110 may collect, from each terminal, namely, each of the terminals 50 including the terminal 10, advertisement request information, generated by at least one of the App drive unit and Web drive unit in the corresponding terminal, including a user key (an App user key or Web user key) and location information.

The verification unit 120 verifies a user key of location information belonging to a specific location area in each time zone based on the result of collection of the specific information collected by the collector 110, namely, the advertisement request information.

More specifically, the verification unit 120 may store/manage the collection result of the advertisement request information (user key+location information) collected by the collection unit 110 as shown in Table 1 below:

TABLE 1

| Collection time | User key | Location information |
|---|---|---|
| 2014 Sep. 12 13:00:00 | a | (23.3, 721.13) |
| 2014 Sep. 12 13:00:25 | b | (48.3, 173.1) |
| 2014 Sep. 12 13:00:30 | c | (72.3, 76.3) |
| . . . | . . . | . . . |

The verification unit 120 may verify a user key of location information belonging to a specific location area in each time zone based on the result of collection of the advertisement request information (user key+location information), that is, Table 1 above.

Thereafter, the verification unit 120 may classify the location areas based on the result of collection of the advertisement request information (user key+location information), namely, Table 1 above.

For example, the verification unit 120 may classify (generate) each location area, i.e., each cluster based on the result of collection of the advertisement request information (user key+location information), namely, Table 1 above, using the technique of exclusive clustering, especially the K-means clustering algorithm.

Of course, it is possible for the verification unit 120 to classify location areas (clusters) using an algorithm different from the K-means clustering algorithm. However, the K-means clustering algorithm is used since its reliability is high.

Accordingly, the verification unit 120 may obtain the result of location area classification in each time zone, as shown in Table 2 below, and the result of location area classification by date, shown in Table 3 below, based on Table 1 above using the K-means clustering algorithm.

TABLE 2

| Time zone | Location area (cluster) | User key |
|---|---|---|
| Sep. 12, 2014, 13:00 | Location area 1 | a |
| | Location area 1 | f |
| | Location area 2 | d |
| . . . | . . . | . . . |

TABLE 3

| Date | Location area (cluster) | User key |
|---|---|---|
| Sep. 11, 2014 | Location area 1 | a |
| | Location area 1 | f |
| | Location area 2 | d |
| . . . | . . . | . . . |

Thereby, the verification unit 120 verifies user keys of location information belonging to a specific location area in each time zone, based on Table 2 obtained based on the result of collection of the advertisement request information collected by the collector 110, namely, Table 1.

Here, the specific location area refers to each of the classified (generated) location areas described above. Hereinafter, for simplicity, location area 1 will be described as an example.

The verification unit 120 may verify user keys of the location information belonging to a specific location area, for example, location area 1, in each time zone based on Table 2 obtained based on the result of collection of the advertisement request information, namely, Table 1. Thereby, the verification unit 120 may verify user keys a, f . . . as shown in Table 2.

The first filtering unit 130 filters a pair of user keys having a probability of belonging to the specific location area greater than or equal to a first predetermined reference value in the same time zone among the user keys verified by the verification unit 120.

In other words, in location area 1 given as a specific location area, the first filtering unit 130 filters a pair of user keys having a probability of belonging to the specific location area, i.e., location area 1, greater than or equal to a first predetermined reference value in the same time zone among the user keys a, f verified by the verification unit 120 based on Table 2.

Here, the first reference value may be set and changed by the operator of the user key identification apparatus 100, and will be assumed to be 60% in the following description.

Hereinafter, the filtering process of the first filtering unit 130 will be described based on location area 1 as the specific location area as described above.

The first filtering unit 130 checks the number of time zones in which the first user key among user keys a, f . . . verified by the verification unit 120 belongs to the specific location area, i.e., location area 1, within a predefined time range.

Here, the predefined time range may be set and changed by the operator of the user key identification apparatus 100. Hereinafter, the predefined time range from 00:00 to 24:00 will be assumed as an example.

The first filtering unit 130 checks the number of the same time zones of the second user key belonging to location area 1 among user keys a, f . . . verified by the verification unit 120 which are the same as time zones of the first user key within the time range (from 00:00 to 24:00).

Then, the first filtering unit 130 calculates the probability of belonging to location area 1 in the same time zone based on the number of time zones of the first user key and the number of the same time zones of the second user key described above. If the calculated probability is greater than or equal to the first reference value (60%), the first filtering unit 130 filters the first user key and the second user key as a user key pair.

The first user key mentioned in the filtering process of the first filtering unit 130 is a user key sequentially selected from among user keys a, f, . . . verified by the verification unit 120 in accordance with the number of times of collection of related specific information (advertisement request information) within the time range (from 00:00 to 24:00).

The second user key mentioned in the filtering process of the first filtering unit 130 is each of the remaining user keys except for the first user key among user keys a, f, . . . verified by the verification unit 120.

For example, it may be assumed that user keys a, f, . . . are listed in descending order of the number of times of collection of the advertisement request information within the time range (from 00:00 to 24:00).

On this assumption, the first filtering unit 130 may perform the filtering process by selecting user key a as the first user key and the remaining user keys f, . . . as the second user key. Thereafter, the first filtering unit 130 may perform the filtering process by selecting user key f as the first user key and the remaining user keys a, . . . as the second user key. In this way, the first filtering unit 130 may perform the filtering process by selecting user keys a, f, . . . one by one as the first user key.

Hereinafter, for simplicity, the filtering process of the first filtering unit 130 will be described in detail, assuming that user key a is the first user key and user key f is the second user key as an example.

In defining the relationship between user key a and user key f, user key a, which is the first user key, may be defined as a Unique key, and user key f, which is the second user key, may be defined as a Second key.

The first filtering unit 130 checks the number of time zones in which the first user key, namely, user key a among user keys a, f, . . . verified by the verification unit 120 belongs to location area 1 within the time range (from 00:00 to 24:00)

For example, when it is assumed that the time zones in which user key a belongs to location area 1 are 00:00, 03:00, 07:00, 10:00, 11:00, 13:00, and 15:00, the first filtering unit 130 will confirm that the number of time zones in which user key a belongs to location area 1 within the time range (from 00:00 to 24:00) is 7.

Then, the first filtering unit 130 checks the number of time zones of the second user key, namely, user key f belonging to location area 1 among user keys a, f, . . . verified by the verification unit 120 which are the same as the time zones of the first user key, namely, user key a within the time range (from 00:00 to 24:00).

For example, when it is assumed that the time zones in which user key f belongs to location area 1 are 00:00, 03:00, 10:00, 11:00, 13:00, and 15:00, the first filtering unit 130 will confirm that the number of the time zones of user key f belonging to location area 1 which are the same as the time zones of user key a is 6.

Thereafter, the first filtering unit 130 may calculate the probability that user key a and user key f belong to location area 1 in the same time zones, based on the number of time zones (7) of the first user key, i.e., user key a and the number (6) of the same time zones of the second user key, i.e., user key f, according to Equation 1 below:

$$\begin{matrix}Probability of belonging to the same location \\ area in the same time zone\end{matrix} = \frac{\begin{matrix}the number of the same time zones \\ for the second user key\end{matrix} }{\begin{matrix}the number of time zones \\ for the first user key\end{matrix}} \times 100 \qquad [ Equation 1 ]$$

Accordingly, the first filtering unit 130 may calculate 6/7*100=85.71% as the probability that user key a and user key f belong to location area 1 in the same time zones according to Equation 1.

If the probability (85.71%) calculated as described above is greater than or equal to a first reference value (60%), the first filtering unit 130 filters user key a and user key f as a user key pair.

The key identification unit 150 identifies the different user keys included in a specific user key pair among user key pairs filtered by the first filtering unit 130 as user keys assigned to the same specific terminal.

Here, the specific user key pair is a user key pair filtered by the second filtering unit 140 among the user key pairs filtered by the first filtering unit 130.

Hereinafter, the second filtering unit 140 will be described.

Based on the result of analyzing the collection results collected by the collector 110 on a date basis, the second filtering unit 140 may filter a user key pair having a probability of belonging to a specific location area on the same date which is greater than or equal to a second predetermined reference value as a specific user key pair among the pairs of user keys filtered by the first filtering unit 130.

Here, the result of analyzing the collection results collected by the collector 110 on a date basis refers to the result of location area classification by date as shown in Table 3 above.

The second reference value may be set and changed by the operator of the user key identification apparatus 100, and will be assumed to be 70% as an example in the following description.

Hereinafter, the filtering process of the second filtering unit 140 will be described, assuming that location area 1 is the specific location area as described above.

The second filtering unit 140 checks the number of time zones in which the first user key included in each user key pair filtered by the first filtering unit 130 belongs to the specific location area within the previous date immediately preceding the current date, and checks the number of the same time zones as those of the first user key in which the second user key included in each user key pair filtered by the first filtering unit 130 belongs to the specific location area within the current date.

The second filtering unit 140 may calculate the probability that each user key pair filtered by the first filtering unit 130 belongs to the specific location area on the same date, based on the number of time zones of the first user key on the previous date and the number of the same time zones of the second user key on the current date.

Accordingly, the second filtering unit 140 may filter a user key pair having a calculated probability equal to or higher than a second reference value (70%) among the user key pairs filtered by the first filtering unit 130 as a specific user key pair.

In this case, the first user key mentioned in the filtering process of the second filtering unit 140 refers to the unique key in the user key pair, and the second user key refers to the second key in the user key pair.

Hereinafter, for simplicity, the filtering process of the second filtering unit 140 will be described in detail based on user key pair a-f among the user key pairs filtered by the first filtering unit 130 as an example.

The second filtering unit 140 checks the number of time zones in which the first user key, namely, user key a included in user key pair a-f belongs to location area 1 within the previous date immediately preceding the current date.

For example, when the current date is Sep. 12, 2014 and the previous date is Sep. 11, 2014, and it is assumed that the time zones in which user key a belongs to location area 1 within Sep. 11, 2014 is 00:00, 03:00, 07:00, 10:00, 11:00, 13:00, and 15:00, the second filtering unit 140 will confirm that the number of time zones in which user key a belongs to location area 1 within Sep. 11, 2014 is 7.

Then, the second filtering unit 140 checks the number of the same time zones of the first user key in which the second user key, namely user key f included in user key pair a-f belongs to location area 1 within the current date.

For example, when the current date is Sep. 12, 2014 and the previous date is Sep. 11, 2014, and it is assumed that the time zones in which user key f belongs to location area 1 within Sep. 12, 2014 are 00:00, 03:00, 07:00, 10:00, 11:00, 13:00, 15:00, and 17:00, the second filtering unit 140 will confirm that the number of the time zones same as those of user key a in which user key f belongs to location area 1 within Sep. 12, 2014 is 7.

Thereafter, the second filtering unit 140 may calculate the probability of belonging to location area 1 on the same date based on the number of time zones (7) of the previous date for the first user key, i.e., user key a and the number (7) of the same time zones of the current date for the second user key, i.e., user key f, according to Equation 2 below:

$$\begin{matrix}Probability of beloinging to the same location \\ area on the same date\end{matrix} = \frac{\begin{matrix}the number of the smae time zones of the \\ current date for the seecond user key\end{matrix}}{\begin{matrix}the number of time zones of the previous date \\ for teh first user key\end{matrix}} \times 100 \qquad [ Equation 2 ]$$

Accordingly, the second filtering unit 140 may calculate 7/7*100=100% as the probability that user key a and user key f in each of user key pair a-f belong to location area 1 on the same date according to Equation 2.

If the probability (100%) calculated as described above is greater than or equal to a second reference value (40%), the second filtering unit 140 filters user key a and user key f in the user key pair a-f as a specific user key pair.

Thereby, the second filtering unit 140 may obtain specific user key pairs as shown in Table 4 below through filtering.

TABLE 4

| Unique key | Second key | Similarity rate | Filtering date |
|---|---|---|---|
| a | f | 100% | Sep. 13, 2014 |
| f | a | 80% | Sep. 13, 2014 |
| f | k | 75% | Sep. 13, 2014 |
| . . . | . . . | . . . | . . . |

Here, the similarity rate means a probability calculated in the filtering process of the second filtering unit 140.

The reason for calculating the probability per date through the filtering by the second filtering unit 140 is that the user of the terminal generally moves and stays in almost the same pattern by regularly going to school, work or the like during work days from Monday through Friday.

The key identification unit 150 identifies different user keys included only in a specific user key pair filtered by the second filtering unit 140 among the user key pairs filtered by the first filtering unit 130 as user keys assigned to the same specific terminal.

More specifically, as can be seen from Table 4 obtained by the second filtering unit 140, regarding user key a and user key f, a specific user key pair a-f having user key a as a Unique key (first user key) and a specific user key pair f-a having user key f as a Unique key (first user key) may be created.

In this case, the key identification unit 150 may delete a specific user key pair, namely, the specific user key pair f-a having the lower similarity rate between the specific user key pair a-f and the specific user key pair f-a.

Also, as can be seen from Table 4 obtained by the second filtering unit 140, specific user key pair f-k of user key f and user key k may be created with specific user key pair a-f of user key a and user key f created.

In this case, the key identification unit 150 may combine the two specific user key pairs a-f and f-k based on a specific user key pair having the higher similarity rate between the specific user key pair a-f and the specific user key pair f-k, namely, based on specific user key pair a-f.

Thereby, the user key identification apparatus 100 may obtain a user key management table such as Table 5 from Table 4 described above.

TABLE 5

| Unique key | Second key | Update date |
|---|---|---|
| a | f, k | 2014 Sep. 13 |
| . . . | . . . | . . . |

The user key identification apparatus 100 may update the user key management table of Table 5 every predetermined period (for example, one month).

Thereafter, for a specific user key pair filtered by the second filtering unit 140 (for example, a specific user key pair a-f, k in Table 5) among the user key pairs filtered by the first filtering unit 130, the key identification unit 150 may identify different user keys a, f and k included in specific user key pair a-f, k as user keys assigned to the same specific terminal.

Hereinafter, for simplicity, the terminal 10 will be referred to as a specific terminal.

Different user keys a, f and k included in the specific user key pair a-f, k may be differently assigned to the App drive unit 14 of the App 13, an App drive unit (not shown) of another application (not shown) and the Web drive unit 12 which are installed in a specific terminal, namely the same terminal 10.

As described above, the user key identification apparatus 100 according to the present disclosure can identify different user keys assigned to the same terminal based on the result of collection and analysis of the advertisement request information including user keys and location information by time zone or date in an environment where multiple different user keys are assigned to one terminal.

Therefore, using the result of identification of the user key identification apparatus 100, an advertisement platform including the user key identification apparatus 100 as an advertisement platform apparatus or an advertisement platform shared by the user key identification apparatus 100 may recognize the advertisement request information in which different user keys such as the user key a and the user key f are verified as the advertisement request information generated in the same terminal (e.g., the terminal 10).

Thus, according to the present disclosure, the accuracy of identifying individual users may be improved and thus the performance of a personalized advertisement service may also be improved in an environment where a plurality of different user keys are assigned to one terminal.

The user key identification apparatus 100 according to the present disclosure may further include a key control unit 160.

The key control unit 160 allows the same user key to be used by both the App drive unit and the Web drive unit installed in the specific terminal.

Hereinafter, the function of the key control unit 160 will be described, on the assumption that the user key management table of Table 5 includes specific user key pair x-y having a user key x as the first user key (i.e., the Unique key) and user key y as the second user key (i.e., the second key).

The inclusion of the specific user key pair x-y in the user key management table of Table 5 may indicate that user key x is assigned to any one of the App drive unit (not shown) and the Web drive unit (not shown) installed in a specific terminal, e.g., the terminal 20 and user key y is assigned to the other one.

In this case, the user key identification apparatus 100 may collect (receive) advertisement request information generated from any one of the App drive unit (not shown) and Web drive unit (not shown) of the terminal 20 using user key y, which is the second key.

Upon receiving the advertisement request information generated using the second key included in specific user key pair x-y, namely, user key y, as described above, the key control unit 160 sends the unique key of specific user key pair x-y, i.e., user key x, to the terminal 20 in response.

Thereby, one of the App drive unit (not shown) and the Web drive unit (not shown) of the terminal 20 that has generated the advertisement request information using user key y, for example, the Web drive unit (not shown) will receive the user key x and store the same in a cookie.

Thereafter, the Web drive unit (not shown) of the terminal 20 generates advertisement request information using the Web user key, namely, user key x stored in the cookie, when necessary.

As a result, upon receiving the advertisement request information generated using the Second key included in specific user key pair x-y, namely, user key y, as described above, the key control unit 160 returns the unique key of specific user key pair x-y, namely, user key x to the terminal 20, allowing both the App drive unit (not shown) and the Web drive unit (not shown) of the terminal 20 to use the same user key, i.e., user key x.

As described above, the user key identification apparatus 100 according to the present disclosure may identify different user keys assigned to the same terminal, and further manage the different user keys assigned to the same terminal with one user key in an environment where a plurality of different user keys are assigned to one terminal.

Thus, with the user key identification apparatus 100 of the present disclosure, it is possible to manage different user keys assigned to the same terminal with one user key, thereby improving the accuracy of identifying individual user and even the performance of the advertisement service.

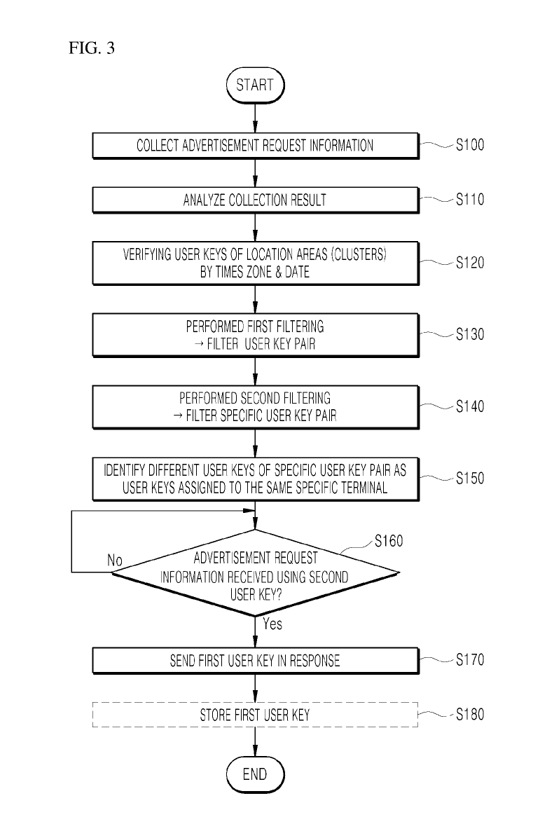

Hereinafter, a method of operating a user key identification apparatus according to an embodiment of the present disclosure will be described in detail with reference to FIG. 3. For simplicity, reference will be made to reference numerals of FIGS. 1 and 2.

In the method of operating the user key identification apparatus 100 according to the present disclosure, advertisement request information generated by at least one of an App drive unit and Web drive unit of each of multiple terminals 50 including the terminal 10 and including a user key (an App user key or a Web user key) and location information is collected from the terminals 50 (S100).

In the method of operating the user key identification apparatus 100, analysis using the K-means clustering algorithm is performed based on the result of collection of the advertisement request information collected in step S100, namely, Table 1 (S110).

Thus, in the method of operating the user key identification apparatus 100, user keys of location information belonging to a specific location area is verified by time zone and date through the analysis based on the result of collection of the advertisement request information collected in step S100, namely, based on Table 1 (S120).

Hereinafter, for simplicity, description will be given of location area 1 as a specific location area.

That is, in the method of operating the user key identification apparatus 100 according to the present disclosure, user keys of location information belonging to a specific location area, namely, location area 1 are verified by time zone based on Table 2, which is obtained through analysis based on the result of collection of the advertisement request information, namely, Table 1.

Further, in the method of operating the user key identification apparatus 100, user keys of location information belonging to the specific location area, namely, location area 1 are verified by date based on Table 3, which is obtained through analysis based on the result of collection of the advertisement request information, namely, Table 1.

Thereafter, in the method for operating the user key identification apparatus 100 according to the present disclosure, a pair of user keys having a probability of belonging to location area 1 in the same time zone which is greater than or equal to a first reference value (e.g., 60%) is filtered among user keys a, f, . . . belonging to location area 1 as verified by time zone in step S120 (S130).

More specifically, in the method of operating the user key identification apparatus 100, the number of time zones in which a first user key among the verified user keys a, f, . . . belongs to location area 1 within a predefined time range (e.g., from 00:00 to 24:00) is checked.

Then, in the method of operating the user key identification apparatus 100, the number of the same time zones of the first user key in which the second user key among the verified user keys a, f, . . . belongs to location area 1 is checked in the time range (from 00:00 to 24:00).

Then, in the method of operating the user key identification apparatus 100, a probability of belonging to location area 1 in the same time zone is calculated based on the number of time zones of the first user key and the number of the same time zones of the second user key described above. If the calculated probability is greater than or equal to a first reference value (60%), the first user key and the second user key described above are filtered as a user key pair.

The first user key mentioned in the filtering process of step S130 is a user key sequentially selected from among user keys a, f, . . . in accordance with the number of times of collection of related specific information (advertisement request information) within the time range (from 00:00 to 24:00).

The second user key mentioned in the filtering process of step S130 is each of the remaining user keys except for the first user key among user keys a, f, . . . .

For example, according to the method of operating the user key identification apparatus 100, when it is assumed that user keys a, f, . . . are listed in descending order of the number of times of collection of the advertisement request information within the time range (from 00:00 to 24:00), the filtering process may be performed by selecting user key a as the first user key and the remaining user keys f, . . . as the second user key. Thereafter, the filtering process may be performed by selecting user key f as the first user key and the remaining user keys a, . . . as the second user key. In this way, the filtering process may be performed by selecting user keys a, f, . . . one by one as the first user key.

Hereinafter, for simplicity, the filtering process of step S130 will be described in detail, assuming that user key a is the first user key and user key f is the second user key as an example.

In defining the relationship between user key a and user key f, user key a, which is the first user key, may be defined as a Unique key, and user key f, which is the second user key, may be defined as a Second key.

In the method of operating the user key identification apparatus 100, the number of time zones in which the first user key, namely, user key a among the verified user keys a, f, . . . belongs to location area 1 within the time range (from 00:00 to 24:00) is checked.

For example, in the method of operating the user key identification apparatus 100, when it is assumed that the time zones in which user key a belongs to locational area 1 are 00:00, 03:00, 07:00, 10:00, 11:00, 13:00, and 15:00, it will be confirmed that the number of time zones in which user key a belongs to location area 1 within the time range (from 00:00 to 24:00) is 7.

Then, in the method of operating the user key identification apparatus 100, the number of the same time zones of the first user key, namely, user key a in which the second user key, namely, user key f, among verified user keys a, f, . . . belongs to location area 1 within the time range (from 00:00 to 24:00) is checked.

For example, in the method of operating the user key identification apparatus 100, when it is assumed that the time zones in which user key f belongs to location area 1 are 00:00, 03:00, 10:00, 11:00, 13:00, and 15:00, it will be confirmed that the number of the same time zones as those of user key a in which user key f belongs to location area 1 is 6.

Thereafter, in the method of operating the user key identification apparatus 100, the probability that user key a and user key f belong to location area 1 in the same time zones may be calculated based on the number of time zones (7) of the first user key, i.e., user key a and the number (6) of the same time zones of the second user key, i.e., user key f, according to Equation 1 described above.

Accordingly, in the method of operating the user key identification apparatus 100, 6/7*100=85.71% may be calculated as the probability that user key a and user key f belong to location area 1 in the same time zones according to Equation 1.

In the method of operating the user key identification apparatus 100, if the probability (85.71%) calculated as described above is greater than or equal to a first reference value (60%), user key a and user key f are filtered as a user key pair.

Thereafter, in the method of operating the user key identification apparatus 100, a pair of user keys having a probability of the user keys belonging to location area 1 on the same date greater than or equal to a second reference value (e.g., 70%) among the user key pairs filtered in step S130 is filtered as a specific user key pair (S140).

Hereinafter, for simplicity, the filtering process of step S140 will be described in detail based on user key pair a-f among the user key pairs filtered in step S130 as an example.

In the method of operating the user key identification apparatus 100, the number of time zones in which the first user key, namely, user key a included in user key pair a-f belongs to location area 1 within the previous date immediately preceding the current date is checked.

For example, in the method of operating the user key identification apparatus 100, when the current date is Sep. 12, 2014 and the previous date is Sep. 11, 2014, and it is assumed that the time zones in which user key a belongs to location area 1 within Sep. 11, 2014 is 00:00, 03:00, 07:00, 10:00, 11:00, 13:00, and 15:00, it will be confirmed that the number of time zones in which user key a belongs to location area 1 within Sep. 11, 2014 is 7.

Then, in the method of operating the user key identification apparatus 100, the number of the same time zones of the first user key, namely, user key a in which the second user key, namely user key f included in user key pair a-f belongs to location area 1 within the current date is checked.

For example, in the method of operating the user key identification apparatus 100, when the current date is Sep. 12, 2014 and the previous date is Sep. 11, 2014, and it is assumed that the time zones in which user key f belongs to location area 1 within Sep. 12, 2014 are 00:00, 03:00, 07:00, 10:00, 11:00, 13:00, 15:00, and 17:00, it will be confirmed that the number of the time zones same as those of user key a in which user key f belongs to location area 1 within Sep. 12, 2014 is 7.

Thereafter, in the method of operating the user key identification apparatus 100, the probability of belonging to location area 1 on the same date may be calculated based on the number of time zones (7) of the previous date for the first user key, i.e., user key a and the number (7) of the same time zones of the current date for the second user key, i.e., user key f, according to Equation 2 above.

Accordingly, in the method of operating the user key identification apparatus 100, 7/7×100=100% may be calculated as the probability that the user key a and the user key fin the user key pair a-f belong to location area 1 on the same date, according to Equation 2 above.

In the method of operating the user key identification apparatus 100, if the probability (100%) calculated as described above is greater than or equal to the second reference value (40%), user key a and user key f in user key pair a-f are filtered as a specific user key pair.

Thereby, in the method of operating the user key identification apparatus 100, specific user key pairs as shown in Table 4 above may be obtained through filtering.

More specifically, as can be seen from Table 4, regarding user key a and user key f, a specific user key pair a-f having user key a as a Unique key (first user key) and a specific user key pair f-a having user key f as a Unique key (first user key) may be created.

In this case, in the method of operating the user key identification apparatus 100, a specific user key pair, namely, the specific user key pair f-a having the lower similarity rate between the specific user key pair a-f and the specific user key pair f-a may be deleted.

Also, as can be seen from Table 4, specific user key pair f-k of user key f and user key k may be created with specific user key pair a-f of user key a and user key f created.

In this case, in the method of operating the user key identification apparatus 100, the two specific user key pairs a-f and f-k may be combined based on a specific user key pair having the higher similarity rate between the specific user key pair a-f and the specific user key pair f-k, namely, based on specific user key pair a-f.

Thereby, in the method of operating the user key identification apparatus 100, a user key management table such as Table 5 may be obtained from Table 4 described above.

Thereafter, in the method of operating the user key identification apparatus 100, for a specific user key pair filtered in step S140, for example, specific user key pair a-f, k seen in Table 5, different user keys a, f and k included in specific user key pair a-f, k as user keys assigned to the same specific terminal (e.g., the terminal 10) (S150).

That is, different user keys a, f and k included in the specific user key pair a-f, k may be differently assigned to the App drive unit 14 of the App 13, an App drive unit (not shown) of another application (not shown) and the Web drive unit 12 which are installed in a specific terminal, namely the same terminal 10.

Furthermore, the method of operating the user key identification apparatus 100 allows the same user key to be used by both the App drive unit and the Web drive unit installed in the specific terminal.

Hereinafter, a description will be given, on the assumption that the user key management table of Table 5 includes specific user key pair x-y having a user key x as the first user key (i.e., the Unique key) and user key y as the second user key (i.e., the second key).

The inclusion of the specific user key pair x-y in the user key management table of Table 5 may indicate that user key x is assigned to any one of the App drive unit (not shown) and the Web drive unit (not shown) installed in a specific terminal, e.g., the terminal 20 and user key y is assigned to the other one.

In this case, in the method of operating the user key identification apparatus 100, advertisement request information generated from any one of the App drive unit (not shown) and Web drive unit (not shown) of the terminal 20 may be collected (received) using user key y, which is the second key (S160).

In the method of operating the user key identification apparatus 100, once the advertisement request information generated using the second key included in specific user key pair x-y, namely, user key y is received (Yes in S160) as described above, the unique key of specific user key pair x-y, i.e., user key x is sent to the terminal 20 in response (S170).

Thereby, one of the App drive unit (not shown) and the Web drive unit (not shown) of the terminal 20 that has generated the advertisement request information using user key y, for example, the Web drive unit (not shown) will receive the user key x and store the same in a cookie (S180).

Thereafter, the Web drive unit (not shown) of the terminal 20 generates advertisement request information using the Web user key, namely, user key x stored in the cookie, when necessary.

As a result, in the method of operating the user key identification apparatus 100 according to the present disclosure, when the advertisement request information generated using the Second key included in specific user key pair x-y, namely, user key y, is received as described above, the unique key of specific user key pair x-y, namely, user key x is returned to the terminal 20, allowing both the App drive unit (not shown) and the Web drive unit (not shown) of the terminal 20 to use the same user key, i.e., user key x.

As described above, with the method of operating the user key identification apparatus according to the present disclosure, different user keys assigned to the same terminal may be identified, and further the different user keys assigned to the same terminal may be managed with one user key in an environment where a plurality of different user keys are assigned to one terminal.

The functional operations and implementations of the subject matter described herein may be implemented as digital electronic circuitry, or may be implemented in computer software, firmware, hardware, including the structures disclosed herein and structural equivalents thereof, or one or more combinations thereof. Implementations of the subject matter described herein may be implemented in one or more computer program products, in other words, one or more modules of computer program instructions encoded on a tangible program storage medium to control operation of a processing system or to be executed by the processing system.

The computer-readable medium may be a machine-readable storage device, a machine-readable storage substrate, a memory device, a composition of material that affects the machine-readable radio wave type signal, or one or more combinations thereof.

As used herein, “system” or “device” includes all kinds of apparatuses and machines for processing data including, for example, a programmable processor, a computer, a multiprocessor, or a computer. In addition to the hardware, the processing system may include, e.g., a code configuring processor firmware, and a code configuring an execution environment for the computer program upon request of, for example, a protocol stack, a database management system, an operating system, or one or more combinations thereof, or the like.

A computer program (also known as a program, software, a software application, a script or a code) may be written in any form of a programming language including a compiled or interpreted language, or a priori or procedural language, and may be deployed in any form including independent programs or modules, components, subroutines, or other units suitable for use in a computer environment. The computer program may not necessarily correspond to a file in a file system. The program may be stored in a single file provided to the requested program, in multiple interactive files (for example, a file storing one or more modules, subprograms or portions of a code), or in a part of a file (for example, one or more scripts stored in a markup language document) containing other programs or data. The computer program may be located on one site or distributed across multiple sites such that it is deployed to run on multiple computers interconnected by a communications network or on one computer.

The computer readable media suitable for storing computer program instructions and data may include, for example, semiconductor memory devices such as an EPROM, an EEPROM and flash memory devices, all sort of non-volatile memories including magnetic disks such as internal hard disks or external disks, and magnetic optical disks, CD-ROM and DVD-ROM disks, a media, and memory devices. A processor and a memory may be supplemented by special purpose logic circuits or integrated therewith.

Implementations of the subject matter described herein may be realized on an arithmetic system including, for example, a back-end component such as a data server, a middleware component such as an application server, a front-end component such as a client computer with a web browser or a graphical user interface allowing a user to interact with the implementations of the subject matter described herein, or one or more combinations of the back-end component, the middleware component, and the front-end component. The components of the system may be interconnected by any form or medium of digital data communications such as, for example, a communication network.

While the present disclosure includes a number of specific implementation details, they are not to be construed as limitations on any invention or the claimable scope. Rather, it should be understood as a description of features that may be specific to a particular embodiment of a particular invention. Similarly, the specific features described herein in the context of individual embodiments may be implemented in combination in a single embodiment. Alternatively, various features described in the context of a single embodiment may also be implemented in multiple embodiments individually or in any suitable sub-combination. Further, although the features may be described as operating in a particular combination and initially claimed as such, one or more features from the claimed combination may in some cases be excluded from the combination, and the claimed combination may be altered to a variant of a sub-combination or sub-combination.

Also, while the present disclosure illustrates operations in the drawings in a particular order, it should not be understood that such operations must be performed in that particular order or sequential order shown in the drawings in order to obtain a desired result, or that all illustrated operations should be performed. In certain cases, multitasking and parallel processing may be advantageous. Also, the separation of the various system components of the above described embodiments should not be understood as requiring such separation in all embodiments, and it should be understood that the program components and systems described above may generally be integrated together into a single software product or packaged into multiple software products.

As such, the present disclosure is not intended to limit the inventions to the specific terms disclosed herein. Thus, although the present disclosure has been described in detail with reference to the above examples, those skilled in the art would conceive alternations, modifications, and deformations on these examples without departing from the scope of the present disclosure. The scope of the present disclosure is defined by the appended claims rather than the description, and it should be construed that all alternations and modifications derived from the meaning and scope of the appended claims and their equivalents are included within the scope of the present disclosure.

1. A user key identification apparatus comprising:
a collector configured to collect specific information including user keys and location information from each terminal;
a verification unit configured to verify user keys of location information belonging to a specific location area in each time zone based on a result of collection of the specific information;
a first filtering unit configured to filter a pair of user keys having a probability of belonging to the specific location area in the same time zone among the user keys verified by the verification unit, the probability being equal to or greater than a first predetermined reference value; and
a key identification unit configured to identify different user keys included in a specific user key pair among user key pairs filtered by the first filtering unit as user keys assigned to the same specific terminal.

2. The user key identification apparatus according to claim 1, further comprising:
a second filtering unit configured to filter a user key pair having a probability of belonging to the specific location area on the same date greater than or equal to a second predetermined reference value among the user key pairs filtered by the first filtering unit as the specific user key pair on the basis of an analysis result obtained by analyzing the result of collection by date.

3. The user key identification apparatus according to claim 1, wherein the specific information is advertisement request information generated by at least one of an application drive unit for requesting and receiving an application-based advertisement in the terminal and a Web drive unit for requesting and receiving a web-based advertisement in the terminal, using a pre-assigned user key.

4. The user key identification apparatus according to claim 1, wherein the different user keys included in the specific user key pair are assigned differently to the application drive unit and the Web drive unit installed in the specific terminal, respectively.

5. The user key identification apparatus according to claim 1, wherein the first filtering unit is configured to:
check the number of time zones of a first user key belonging to the specific location area within a predefined time range among the user keys verified by the verification unit;
check the number of time zones of a second user key belonging to the specific location area same as the time zones of the first user key within the time range among the user keys verified by the verification unit;
calculate a probability of belonging to the specific location area in the same time zones based on the number of the time zones of the first user key and the number of the same time zones of the second user key; and
filter, when the calculated probability is greater than or equal to the first reference value, the first user key and the second user key as a user key pair.

6. The user key identification apparatus according to claim 5, wherein the first user key is a user key sequentially selected from among the user keys verified by the verification unit according to the number of times of collection of related specific information within the time range,
wherein the second user key is each of remaining user keys except for the first user key among the user keys verified by the verification unit.

7. The user key identification apparatus according to claim 2, wherein the second filtering unit is configured to:
check, for each of the user key pairs filtered by the first filtering unit, the number of time zones of a first user key belonging to the specific location area within a previous date immediately preceding a current date and the number of time zones of the current date of a second user key belonging to the specific location area the same as the time zones of the first user key;
calculate, for each of the user key pairs filtered by the first filtering unit, a probability that the first user key and the second user key belong to the specific location area on the same date, based on the number of the time zones of the first user key on the previous date and the number of the same time zones of the second user key on the current date; and
filter a user key pair having the calculated probability greater than or equal to the second reference value among the user key pairs filtered by the first filtering unit as a specific user key pair.

8. The user key identification apparatus according to claim 3, wherein the different user keys included in the specific user key pair comprises a first user key assigned to one of the application drive unit and the Web drive unit installed in the specific terminal, and a second user key assigned to the other one of the application drive unit and the Web drive unit,
the user key identification apparatus further comprising:
a key control unit configured to send the first user key upon receiving the advertisement request information generated using the second user key from any one of the application drive unit and the Web drive unit such that both the application drive unit and the Web drive unit installed in the specific terminal use the first user key.

9. A method of operating a user key identification apparatus, comprising:
performing a collecting step of collecting specific information including user keys and location information from each terminal;
performing a verifying step of verifying user keys of location information belonging to a specific location area in each time zone based on a result of collection of the specific information;
performing a first filtering step of filtering a pair of user keys having a probability of belonging to the specific location area in the same time zone among the user keys verified by the verification unit, the probability being greater than or equal to a first predetermined reference value; and
performing a key identifying step of identifying different user keys included in a specific user key pair among the user key pairs filtered in the first filtering step as user keys assigned to the same specific terminal.

10. The method according to claim 9, further comprising:
performing a second filtering step of filtering a user key pair having a probability of belonging to the specific location area on the same date greater than or equal to a second predetermined reference value among the user key pairs filtered by the first filtering unit as the specific user key pair on the basis of an analysis result obtained by analyzing the result of collection by date.

11. The method according to claim 9, wherein the different user keys included in the specific user key pair are assigned differently to a application drive unit and a Web drive unit installed in the specific terminal, respectively.

12. The method according to claim 9, wherein the first filtering step comprises:
checking the number of time zones of a first user key belonging to the specific location area within a predefined time range among the user keys verified in the verifying step;
checking the number of time zones of a second user key belonging to the specific location area same as the time zones of the first user key within the time range among the user keys verified in the verifying step;
calculating a probability of belonging to the specific location area in the same time zones based on the number of the time zones of the first user key and the number of the same time zones of the second user key; and
filtering, when the calculated probability is greater than or equal to the first reference value, the first user key and the second user key as a user key pair.

13. The method according to claim 10, wherein the second filtering step comprises:
checking, for each of the user key pairs filtered in the first filtering step, the number of time zones of a first user key belonging to the specific location area within a previous date immediately preceding a current date and the number of time zones of the current date of a second user key belonging to the specific location area the same as the time zones of the first user key;
calculating, for each of the user key pairs filtered in the first filtering step, a probability that the first user key and the second user key belong to the specific location area on the same date, based on the number of the time zones of the first user key on the previous date and the number of the same time zones of the second user key on the current date; and
filtering a user key pair having the calculated probability greater than or equal to the second reference value among the user key pairs filtered in the first filtering step as a specific user key pair.

14. The method according to claim 9, wherein the different user keys included in the specific user key pair comprises a first user key assigned to one of the application drive unit and the Web drive unit installed in the specific terminal, and a second user key assigned to the other one of the application drive unit and the Web drive unit,
the method further comprising:
sending the first user key upon receiving the advertisement request information generated using the second user key from any one of the application drive unit and the Web drive unit such that both the application drive unit and the Web drive unit installed in the specific terminal use the first user key.
